(19) United States
(12) Patent Application Publication
(10) Pub. No.: US 2018/0228088 A1
(43) Pub. Date: Aug. 16, 2018

(54) SUPPORT BAR OF A CROP LIFTER FOR HARVESTED CROPS

(71) Applicant: Gebr. Schumacher Gerätebaugesellschaft mbH, Eichelhardt (DE)

(72) Inventor: Frank Höller, Stein Wingert (DE)

(73) Assignee: Gebr. Schumacher Gerätebaugesellschaft mbH, Eichelhardt (DE)

(21) Appl. No.: 15/580,801

(22) PCT Filed: May 31, 2016
(86) PCT No.: PCT/EP2016/062238

§ 371 Date: Dec. 8, 2017

(30) Foreign Application Priority Data
Jun. 12, 2015 (EP) 15171844.2

(51) Int. Cl. A01D 65/02

(52) U.S. Cl. CPC A01D 65/02; A01D 34/14

(57) ABSTRACT

The invention relates to a support bar (5) of a crop lifter (10) for harvested crops, having a main direction of extension (X). A portion (12) designed as a sliding skid is arranged between a first end (8) and a second end (9) of the support bar (5). The invention also relates to a crop lifter (10) for a cutter bar of a harvesting machine, comprising a stalk lifter and a support bar (5) carrying said stalk lifter.

### BACKGROUND OF THE INVENTION

### Field of the Invention

The invention relates to a support bar of a crop lifter for crops, having a main extension direction, wherein between a first end and a second end of the support bar a portion formed as a skid is arranged, as well as to a crop lifter for a mower of a harvesting machine, having a stalk lifter and a support bar carrying the stalk lifter.

### Background

In known mowers of harvesting machines mowing fingers are arranged distributedly along a sickle bar, which mowing fingers guide the sickle bar and form the counter blades for the mowing blades. To be able to mow securely bent or lying down stalks crop lifters are used, which lift the stalks. Generically, the crop lifters have a support bar and a stalk lifter. The support bar serves as the attachment of the crop lifter on the sickle bar of the mower and guides the stalk lifter, on which upper side the stalks are lifted. During the operation of the harvesting machine, the support bar has to be guided with a small distance above the surface of the ground, so that bent or lying down stalks can be lifted if possible completely and reliably by the stalk lifter. The portion of the support bar arranged next to the ground drags in this case nearly always, as a skid, along the surface of the ground. Because of the increasing working velocities of the harvesters and the unevenness of the surface of the ground, the support bar is subjected to considerable abrasive wear.

From DE 101 23 248 C1 a crop lifter is known, in which the support bar is formed in a bending resistant manner in an area between the second end and a holder by means of a profiling. The immediate area at the second end is already sufficiently stiff because of the attachment of the stalk lifter on the support bar, so that the profiling extends into the subsequent area. This is especially the skid-like portion, with which the support bar rests on the ground, and the then following portion up to the holder. For this, the support bar is bulged arch-like in this area, when seen in cross-section.

From citation WO 2011/143681 A1 a crop lifter is known, in which in the front part of the lower surface area of the crop lifter, which according to the purpose slides during operation often on the ground, a face is arranged, wherein this face is provided with a wear plating from a material differing from the material of the support bar, wherein the wear plating is formed by an exchangeable plating part mounted on the crop lifter.

An object of the invention is to improve a support bar for a crop lifter in relation to at least one of the characteristics wear, bending stiffness or torsional stiffness by means of a profiling further refined in relation to the state of the art.

### SUMMARY OF THE INVENTION

The object is met according to the invention by a support bar of a crop lifter and by means of a crop lifter according to the independent claims. In the dependent claims preferred embodiments and advantageous improvements are stated.

The support bar according to the invention of a crop lifter for crops has a main extension direction, wherein between a first end and a second end of the support bar a portion formed as a skid is arranged. The main extension direction is also designated as longitudinal axis, wherein this is not to be understood as a straight line, but should be defined along the support bar bent generally in longitudinal direction. The portion formed as a skid is also designated simply as a skid. The skid is preferably formed by a portion of the support bar itself, but can, however, also be arranged as a separate component on the support bar.

According to the invention it is provided, that the portion formed as a skid is provided, in sectional view transversally to the main extension direction, with an undulated contour. Undulated means in the sense of the invention, that the contour forms at least a wave length when seen in cross-section, for example in the sense of an S-form with a wave crest and a wave trough. The undulated contour is formed along the portion formed as a skid continuously or only portion-wise. Portion-wise means, that the undulated contour can for example be disrupted.

An advantage of the support bar according to the invention is, that by means of the undulated contour a contour, which is more bending resistant compared to a simply bulged contour, is made available, which wear characteristics are additionally improved. Furthermore, the undulated contour has advantageously a higher torsional resistance than a simply bulged contour.

The crop lifter according to the invention for a mower of a harvester has a stalk lifter and a support bar carrying the stalk lifter, wherein a portion of the support bar formed as a skid comprises at least, when seen in a sectional view transversally to the main extension direction, an undulated contour. For example, the support bar comprises a first end, which is attachable on the mower, and a second end, on which the stalk lifter is arranged, wherein the support bar extends between the first end and the second end along the longitudinal axis. The support bar is guided with the portion formed as a skid during operation closely above the ground and contacts this, depending more or less on the mower and the crops. Thus, the skid is subjected to a significant wear by means of abrasion. Attachable on the mower means, in the sense of the invention, that the first end of the support bar has a corresponding design, which enables the attachment on the mower. The stalk lifter is for example welded to the support bar, however can also be attached in a reversible manner. The support bar can be manufactured mainly from metal, especially from sheet steel. The invention relates however also explicitly to support bars or crop lifters, which are manufactured as a whole or partially from plastic components.

Preferably, it is provided, that the skid comprises, when seen in sectional view transversally to the longitudinal axis, an undulated contour with at least two wave crests on a side of the support bar facing away from the stalk lifter. The side of the support bar facing away from the stalk lifter is that side, which during operation touches the ground and is in the following designated as the outer side. According to a preferred embodiment the portion formed as a skid is also provided to be guided with its outer side along a ground, wherein at least two wave crests of the undulated contour project upwards from the outer side. Thus, the direction of the at least two wave crests is defined, to be precise in assembly position in direction to the ground. The person skilled in the art realises, that the wave crests are however also formed on the inner side of the skid, arranged opposite to the outer side, to be precise in assembly position as a notching in direction to the ground.

An advantage of the undulated contour with at least two wave crests on the outer side, which is designated also here as wave contour, is that the support bar thus offers a higher stability once the wear in the area of the skid advances. In support bars with simple bulging according to the state of the art, a forming of a hole in their centre appears when the skid is being worn down. The hole gets larger with increasing wear. In contrast thereto by means of the wave contour according to the invention, with two wave crests, two elongated slots are produced, which width together is smaller than the width of a single hole, and their area is smaller than the area of the hole. Furthermore, when seen in cross-section, because of the wave trough arranged between the wave crests, a centre bar remains between the elongated slots, which provides the support bar with additional bending stiffness during advancing wear. As a whole, thus, a longer service life of the support bar according to the invention or of the crop lifter according to the invention is achieved.

According to a further preferred embodiment it is provided, that the portion formed as a skid comprises lateral flanks, wherein the lateral flanks are angled to an inner side arranged opposite to the outer side. The angle, which the flanks take up with a horizontal of the contour is preferably more than 30 degrees, especially preferably approximately 40 degrees and at a maximum approximately 90 degrees.

According to a preferred embodiment it is provided, that the undulated contour varies along a length of the portion formed as a skid in its shape. The shape is the contour height, i.e. especially the distance between the wave crests and the wave troughs. The shape of the contour decreases especially preferably starting from a central sector of the portion formed as a skid towards both directions. Furthermore, it is especially provided in a preferable manner, that the contour comprises exactly one wave trough between exactly two wave crests, wherein the height of the two wave crests can respectively be the same in relation to the wave trough. The contour is formed preferably mirror-symmetrically in a plane aligned in the main extension direction.

According to a further preferred embodiment of the support bar, a wear protection layer is deposited on the outer side of the skid. Especially in a preferred manner, the wear protection layer is deposited along the whole width of the contour. Alternatively, the wear protection layer is deposited only between the wave crests.

A further advantage of the undulated contour with at least two wave crests is that this offers compared to the state of the art an advantageous possibility, to deposit the wear protection layer on the skid. To fill the wave trough between the wave crests with a filler material as wear protection layer, has the advantage, that the filler material can be arranged there with a maximal thickness, where the wear is the largest. In contrast thereto, a sheet material would only be worn in partial areas.

According to a further preferred embodiment it is thus provided, that the contour comprises respectively one wave trough between two neighbouring wave crests, wherein at least one wave trough is filled at least partially by the wear protection layer. In this case, it is especially preferred to deposit the wear protection layer flush in the wave trough. According to an alternative embodiment, the wear protection layer is deposited projecting beyond the wave crests.

A material of the wear protection layer is preferably selected such, that a wear characteristic of the wear protection layer is comparable to the wear characteristic of the portion formed as a skid. However, it can also be advantageous, depending on the intended purpose, to provide the filler material slightly or distinctly more wear resistant than the skid itself or even less wear resistant.

Furthermore, it is preferred, to select the material of the wear protection layer such, that a hardness of the wear protection layer is comparable to a hardness of the portion formed as a skid. It can also be provided in a preferred manner, to provide the filler material depending on the intended purpose slightly or distinctly harder than the skid itself, or even less hard.

Thus, according to a further preferred embodiment it is provided, that in the contour with respectively one wave trough between two neighbouring wave crests at least one blocking burling is arranged for accumulating material of the ground in at least one wave trough. Preferably, several blocking burlings are provided for each wave trough, especially two blocking burlings. As a blocking burling serves any obstacle, arranged in the wave trough, which enables an accumulation of material of the ground. Especially preferable the blocking burlings are placed as welding spots into the wave trough. The accumulated material of the ground serves advantageously as a wear protection for the skid.

As a further embodiment a contour would be possible, in which the wave crests or wave troughs arranged therebetween, are not formed by means of an essentially bending deformation of the area provided as the skid, but by means of compression moulding, forging or casting, so that the wave crests also project as an elevated shape. In this case the wave crests do not necessarily have to be formed with a constant width in direction of the longitudinal axis. The wave crests neither have to extend in a straight line, but can also for example be formed meanderingly.

### BRIEF DESCRIPTION OF THE DRAWINGS

Followingly, the invention is described in detail by means of exemplary embodiments, referring to the attached drawings. The remarks are only exemplary and do not limit the general idea of the invention.

It shows

FIG. 1 a crop lifter with a support bar according to the state of the art, on a mower of a harvesting machine,

FIGS. 2a and 2b two views of a support bar according to the state of the art respectively in a sectional view,

FIGS. 3 and 4 two views of an embodiment of a support bar according to the invention,

FIGS. 5a to 5e five views, respectively in a sectional view transversal to the main extension direction of the support bar corresponding to the intersection lines of FIG. 4,

FIGS. 6a, 6b and 6c a wear of the support bar according to the invention of FIGS. 3 and 4,

FIGS. 7a, 7b and 7c a wear of the support bar according to the state of the art of FIGS. 2a and 2b,

FIGS. 8a and 8b two views of a further embodiment of the support bar according to the invention respectively in a sectional view,

FIGS. 9a to 9d four further embodiments of the support bar according to the invention of FIG. 8b, respectively in a sectional view transversally to the main extension direction,

FIGS. 10a to 10c three views of a further embodiment of the support bar according to the invention respectively in a sectional view,

FIG. 11 a further embodiment of the support bar according to the invention in a sectional view.

### DETAILED DESCRIPTION OF THE INVENTION

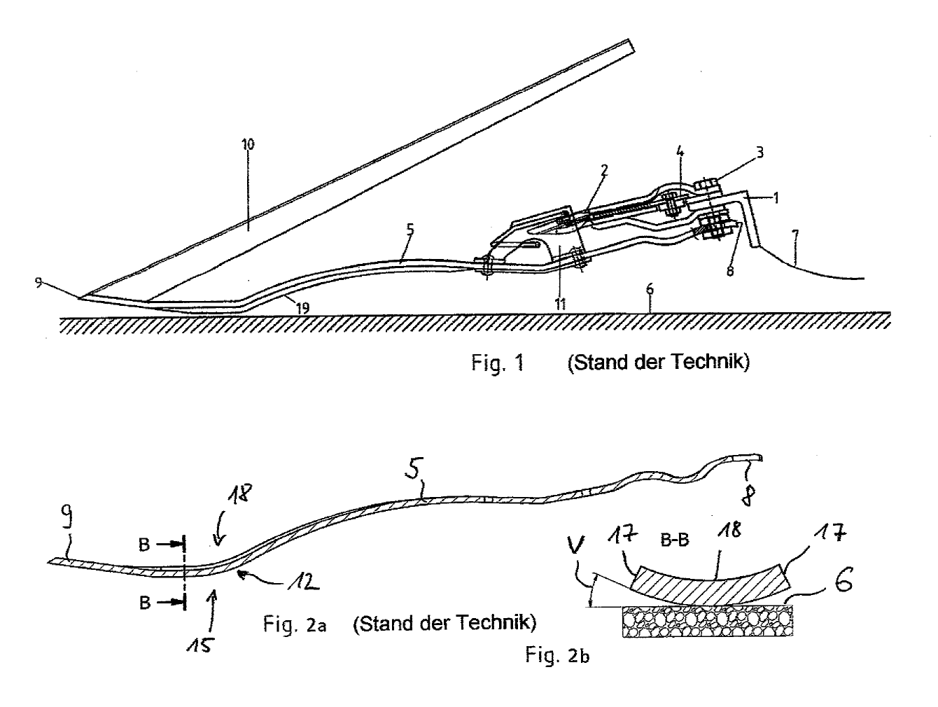

In FIG. 1 an embodiment of a crop lifter with a support bar 5 according to the state of the art is shown. A sickle bar 1 is shown in a schematical representation, from which a mowing finger 2 is shown projectingly. This is attached by means of a screw 3 on the sickle bar 1. Several further mowing fingers 2 are assigned to the sickle bar 1 with distance to each other into the drawing plane and out of the drawing plane. The mowing fingers 2 serve for guiding a cutter bar 4, which comprises mowing blades for separating the crops. The mowing finger 2 is arranged inclined with lowered cutting table at an angle of approximately 18° with its tip to the ground 6, so that it can be cut as low as possible, without having to lower the cutting table so far, that the cutting unit tray 7 abuts the ground 6. A first end 8 of the support bar 5, manufactured from a flat material as initial material, is for example attachable via a yoke-like means with a disc, having an annular groove, which is attached via the screw 3, on the sickle bar 1. On a second end 9, distanced from the first end 8, a stalk lifter 10, which extends at an angle to the support bar inclined upwards in direction to the sickle bar 1, is mounted on the support bar 5. The support bar 5 is supported by means of a holder 11 on the mowing finger 2 or its upper face facing away from the support bar 5.

FIGS. 2a and 2b show two views of a support bar 5 according to the state of the art, respectively in a sectional view, wherein the support bar 5 is largely comparable to that of FIG. 1. FIG. 2a shows the support bar 5 in a sectional view along the main extension direction from the first end 8 to the second end 9. An outer side 15 is facing the ground 6 during operation of a harvesting machine. The portion 12 of the support bar 5, formed as a skid, is provided to glide over the ground 6 and is correspondingly subjected to a significant wear. FIG. 2b shows a sectional view B-B of FIG. 2a, transversally to the main extension direction through the portion 12 formed as a skid. Therein is the, seen from an inner side 18 of the support bar 5, simple concave bulge recognizable in the area of the skid 12, by means of which an angle V is formed between the flanks 17 of the skid and the ground 6.

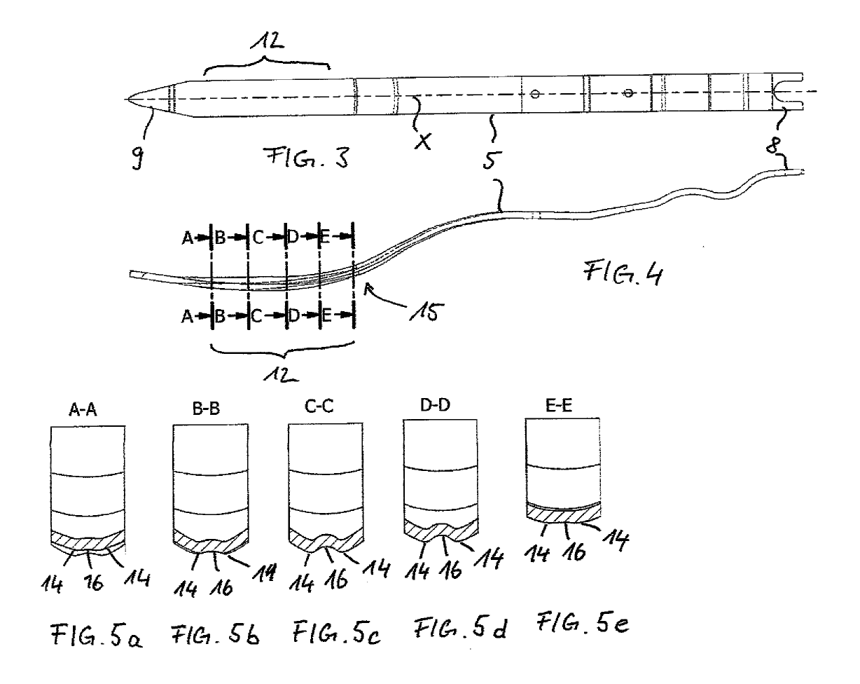

FIGS. 3 and 4 show respectively views of a first embodiment of a support bar 5 according to the invention, which is shown in the following respectively without stalk lifter, attachment elements or cutter unit. The configuration of the crop lifter shown in FIG. 1 is only exemplary. The arrangement of the support bar 5 to the stalk lifter or the cutter unit can deviate therefrom. The support bar 5 according to the invention comprises a first end 8 and a second end 9. The support bar 5 extends between the first end 8 and the second end 9 along a main extension direction or longitudinal axis X and comprises a portion 12, formed as a skid and which also for simplification is only designated as skid 12.

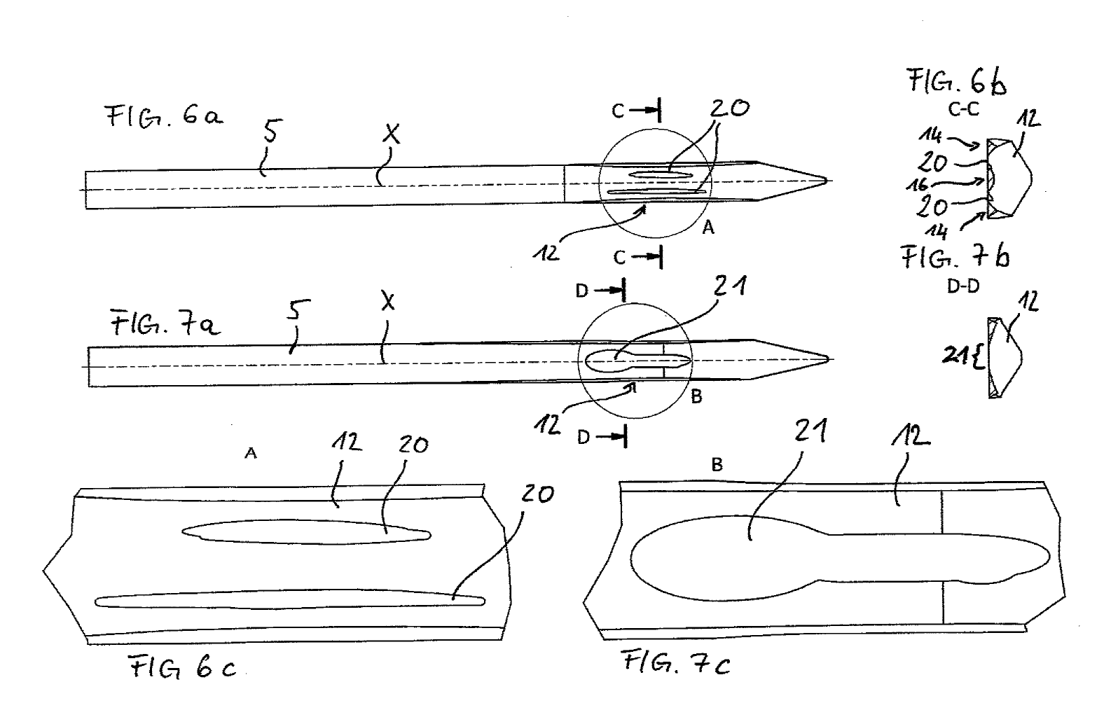

In FIGS. 5a to 5e it is visible, that the support bar 5 has in the area of the skid 12, when seen in different sectional views transversally to the main extension direction X, extending at a right angle to the drawing plane, respectively an undulated contour. The shown embodiment of the support bar 5 comprises two wave crests 14 on an outer side 15 of the support bar 5. The outer side 15 is the side facing the ground 6 during operation. FIGS. 5a to 5e show five, consecutive sectional views of the skid 12 in approximately constant distances, starting close to the front end 9. Thus, it is illustrated, that the undulated contour along the main extension direction X along the length of the portion 12 formed as a skid, varies in its shape.

FIG. 5a shows a sectional view along the intersection line A-A of FIG. 4. The undulated contour, comprising the wave crests 14 and the wave trough 16 arranged therebetween, is here at the front edge of the skid 12 facing the second end 9, only slightly shaped.

FIG. 5b shows a sectional view along the intersection line B-B of FIG. 4. The undulated contour, comprising the wave crests 14 and the wave trough 16 arranged therebetween, is here between the edge and the centre of the skid 12, formed more distinctly, than in FIG. 5a.

FIG. 5c shows a sectional view along the intersection line C-C of FIG. 4. The undulated contour comprising the wave crests 14 and the wave trough 16 arranged therebetween, is here approximately in the centre of the skid 12, formed most distinctly.

FIG. 5d shows a sectional view along the intersection line D-D of FIG. 4. The undulated contour, comprising the wave crests 14 and the wave trough 16 arranged therebetween is here between the centre and the edge of the skid 12, formed slightly less distinctly, than in FIG. 5c.

FIG. 5e shows a sectional view along the intersection line E-E of FIG. 4. The undulated contour, comprising the wave crests 14 and the wave trough 16 arranged therebetween, is here at the rear edge of the skid 12, distanced from the second end 9, formed much less pronounced than in the centre.

FIGS. 5a to 5e show, that the undulated contour varies along a length of the portion formed as a skid 12 in its shape, wherein the shape of the contour decreases starting from a central sector (FIG. 5c) of the portion formed as a skid 12 in both directions. Preferably, the contour has exactly one wave trough 16 between exactly two wave crests 14, wherein the height of the two wave crests 14 is respectively the same in relation to the wave trough 16.

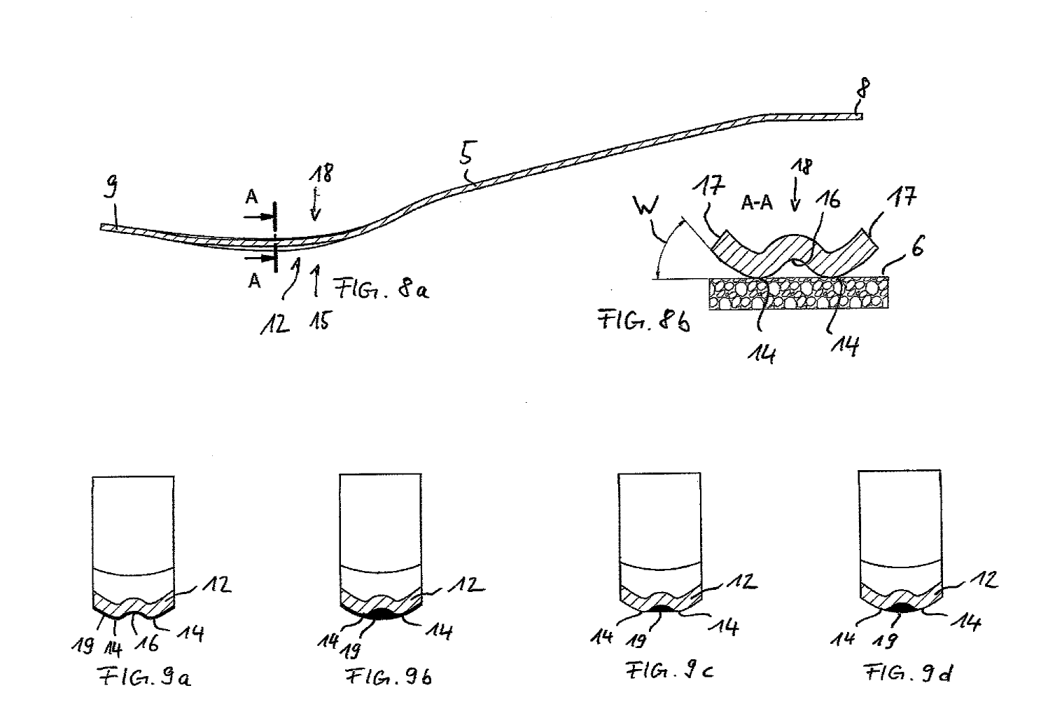

FIGS. 6a to 6c and 7a to 7c serve for the representation of the wear characteristics at the support bar 5 according to the invention of FIGS. 3 and 4 in comparison to the support bar according to the state of the art of FIGS. 2a and 2b. The wear is graphically represented qualitatively in form of elongated slots 20 and holes 21, wherein the graphic representations of the wear are based on actual wear experiments with the different support bars 5 under comparable conditions.

FIGS. 6a, 6b and 6c show the support bar 5 according to the invention, wherein in the view of FIG. 6a in the area of the skid 12, elongated slots 20 are visible as wear characteristics. The elongated slots 20 are shown enlarged in the detail A in FIG. 6c. FIG. 6b shows the skid 5 in a sectional view C-C through the skid 12 transversally to the main extension direction X, in which the slots 20 are visibly arranged in the area of the wave crests 14 of the undulated contour according to the invention, wherein the wave crests 14 and the wave trough 16 are only rudimentary visible because of the advanced wear in FIG. 6b.

FIGS. 7a, 7b and 7c show the support bar 5 according to the state of the art, wherein in the view of FIG. 7a in the area of the skid 12, wear is visible. In contrast to the elongated slots 20 in detail A of FIG. 6c, a continuous, essentially wider wear portion 21, which for the differentiation is, in this case, designated as a hole 21, is visible in detail B of FIG. 7c. FIG. 7b shows the support bar 5 in a sectional view D-D through the skid 12, transversally to the main extension direction X, in which the hole 21 is formed visibly approximately centred in the apex portion of the simple bulging of the skid 12. Especially, the comparison of the detailed views A of FIG. 6c and B of FIG. 7c shows, that the support bar 5 has in the area of the skid 12 with the undulated contour according to the invention a higher stability, as the two elongated slots 20 act less destabilising than the hole 21, especially as the latter extends across an essentially larger portion of the width transversally to the main extension direction X, than the two elongated slots 20 together.

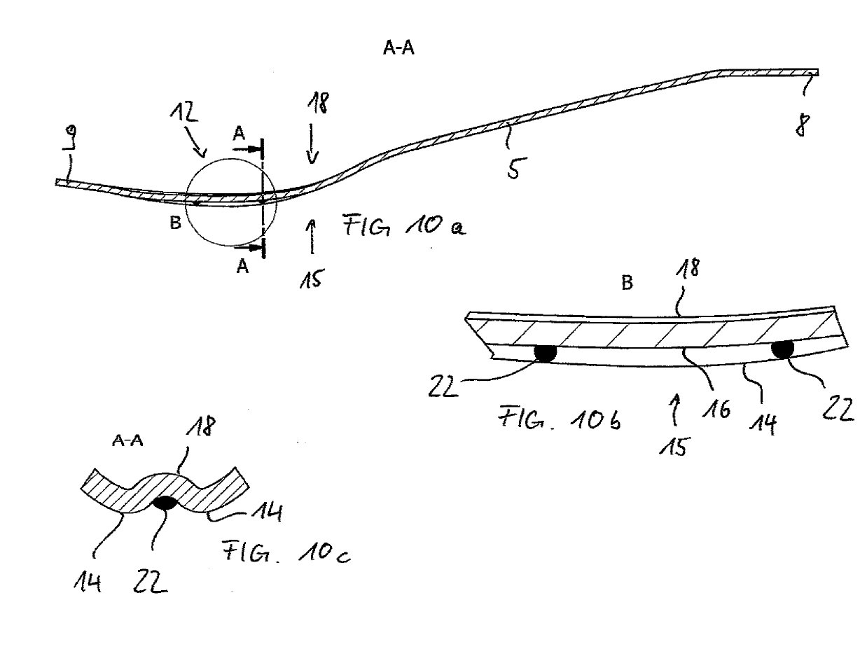

FIGS. 8a and 8b show a further embodiment of the support bar 5 according to the invention, which differs from the embodiment of FIG. 3 initially essentially because of the flatter extension in the area of the first end 8. FIG. 8a shows a sectional view through the skid 12 transversally to the main extension direction X corresponding to the intersection line A-A of FIG. 8a. The undulated contour according to the invention comprising two wave crests 14 and one wave trough 16 at the outer side 15, has in this embodiment a further difference to the state of the art, which is especially visible when comparing FIGS. 8b and 2b. The flanks 17 of the undulated contour in the area of the skid 12 are in the embodiment of FIG. 8b stronger inclined in direction to the inner side 18 than in the simple concave bulged contour according to the state of the art of FIG. 2b. The angle W between the ground 6 and the flank 17 is thus larger than the angle V in the simple concavely bulged contour, which generally is approximately 25 degrees. In the undulated contour according to the invention the angle W is preferably at least 30 degrees and up to 90 degrees. The steeper flanks 17 allow a better displacement of ground material and furthermore contribute to the bending stiffness in the main extension direction and to the torsional stiffness of the support bar 5.

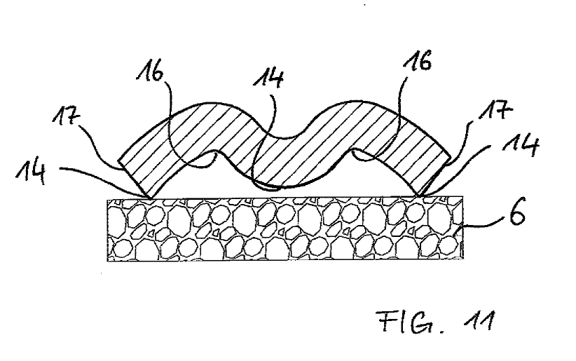

In FIGS. 9a to 9d four further embodiments of the support bar 5 are shown. Only one sectional view through the skid 12, transversally to the main extension direction X, which in this case is arranged at a right angle to the drawing plane, is shown. The embodiments of FIGS. 9a to 9d have in common, that a wear protection layer 19 is deposited on the outer side 15 of the skid 12.

According the support bar 5 of FIG. 9a the wear protection layer 19 is deposited across the whole width of the undulated contour. According to the support bar 5 of FIG. 9b it is provided, that the wear protection layer 19 is deposited projecting beyond the wave crests 14.

In the support bar 5 of FIG. 9c, the wear protection layer 19 is not deposited across the whole width of the undulated contour, but only the wave trough is filled by the wear protection layer 19. Expressed more precisely, the wear protection layer 19 is filled flush with the wave crests 14 into the wave trough 16. In the support bar 5 of FIG. 9b it is again provided, that only the wave trough 16 is filled with the wear protection layer 19, in this case, however, this is deposited projecting beyond the wave crests 14.

A further embodiment of the support bar 5 is shown in FIGS. 10a, 10b and 10c. FIG. 10a shows a sectional view longitudinally to the main extension direction X, FIG. 10c shows an enlarged sectional view transversally thereto, corresponding to the intersection line A-A. FIG. 10b shows enlarged the detail B of FIG. 10a. The embodiment has an undulated contour of the skid comprising two wave crests 14 on the outer side 15. In the wave trough 16, two obstacles, designated as blocking burlings 22, are arranged and which ensure during operation, that the ground material is accumulated in the wave trough 16, which acts as a wear protection for the skid 12. The blocking burlings 22 can, for example, be welding spots, which are arranged in the wave trough 16.

In FIG. 11 a further embodiment of the support bar according to the invention is shown in a sectional view, wherein the representation is comparable to the embodiment shown in FIG. 8b. The embodiment of FIG. 11 illustrates, that the portion 12 formed as a skid can have in the sectional view transversally to the main extension direction an undulated contour comprising more than two wave crests 14. In the shown embodiment, the contour of FIG. 8b is arranged turned by 180 degrees in principle, so that additionally to a middle wave crest 14 also two wave crests 14 at the flanks 17 are facing the ground 6. Correspondingly two wave troughs 16 are arranged between the wave crests 14. Alternatively, one or both flanks 17 can be bent again upwards away from the ground 6.

### REFERENCE NUMERALS LIST

1 sickle bar

2 mowing finger

3 screw

4 cutter bar

5 support bar

6 ground

7 cutting unit tray

8 first end of the support bar

9 second end of the support bar

10 stalk lifter

11 holder

12 skid

14 wave crest

15 outer side

16 wave trough

17 flank

18 inner side

19 wear protection layer

20 gap

21 hole

22 blocking burling

V, W angle

X main extension direction, longitudinal axis

1. Support bar of a crop lifter for crops, having a main extension direction, wherein between a first end and a second end of the support bar a portion formed as a skid is arranged,
characterised in
that the portion formed as a skid has at least portion-wise an undulated contour in a sectional view transversal to the main extension direction.

2. Support bar according to claim 1, characterised in that the portion formed as a skid is provided to be guided with an outer side over a ground, wherein at least two wave crests of the undulated contour project from the outer side.

3. Support bar according to claim 2, characterised in that the portion formed as a skid comprises lateral flanks, wherein the lateral flanks are angled to an inner side arranged opposite to the outer side.

4. Support bar according to claim 1, characterised in that the portion formed as a skid is formed mirror-symmetrically in a sectional view transversal to the main extension direction.

5. Support bar according to claim 1, characterised in that the undulated contour varies in shape along the main extension direction over a length of the portion formed as a skid, in particular the shape is tapering off from a central sector of the portion formed as a skid towards both directions.

6. Support bar according to claim 2, characterised in that a wear protection layer is deposited on the outer side.

7. Support bar according to claim 6, characterised in that the wear protection layer is deposited along a whole width of the contour.

8. Support bar according to claim 6, characterised in that the contour comprises, respectively, a wave trough between two neighbouring wave crests, wherein the wave trough is filled at least partially by the wear protection layers.

9. Support bar according to claim 8, characterised in that the wear protection layer is deposited flush in the wave trough.

10. Support bar according to claim 8, characterised in that the wear protection layer is deposited projecting beyond the wave crests.

11. Support bar according to claim 6, characterised in that a material of the wear protection layer is selected such, that a wear characteristic of the wear protection layer is comparable to a wear characteristic of the portion formed as a skid.

12. Support bar according to claim 6, characterised in that a material of the wear protection layer is selected such, that a hardness of the wear protection layer is comparable to a hardness of the portion formed as a skid.

13. Support bar according to claim 1, characterised in that the contour comprises, respectively, a wave trough between two neighbouring wave crests, wherein at least one blocking burling is arranged for accumulating material of the ground in each wave trough.

14. Support bar according to claim 1, characterised in that the contour has exactly one wave trough between two wave crests, wherein a height of the two wave crests is equal relative to the wave trough.

15. Crop lifter for a mower of a harvesting machine, having a stalk lifter and a support bar supporting the stalk lifter according to claim 1.
